(19) United States
(12) Patent Application Publication
(10) Pub. No.: US 2013/0178361 A1
(43) Pub. Date: Jul. 11, 2013

(54) PROCESS FOR PRODUCING DISPERSION OF COPPER ION-MODIFIED TUNGSTEN OXIDE PHOTOCATALYST

(71) Applicant: Yasuhiro Hosogi, Toyama (JP)

(72) Inventor: Yasuhiro Hosogi, Toyama (JP)

(73) Assignee: SHOWA DENKO K.K., Minato-ku, Tokyo (JP)

(21) Appl. No.: 13/809,105

(22) PCT Filed: Jul. 8, 2011
(86) PCT No.: PCT/JP2011/066169

§ 371 Date: Mar. 25, 2013

(30) Foreign Application Priority Data
Jul. 9, 2010 (JP) 2010-156710

(51) Int. Cl. B01J 23/885

(52) U.S. Cl. CPC B01J 23/885
USPC 502/318

(57) ABSTRACT

The present invention relates to a process for producing a dispersion of a copper ion-modified tungsten oxide photocatalyst, including the steps of subjecting copper ion-modified tungsten oxide particles to mechanical pulverization treatment in a solvent and then contacting the resulting dispersion of the pulverized particles with an oxygen gas or ozone; and a copper ion-modified tungsten oxide photocatalyst which is produced by subjecting copper ion-modified tungsten oxide particles to mechanical pulverization treatment in a solvent and then contacting the resulting dispersion of the pulverized particles with an oxidative gas, wherein a photocatalyst powder obtained by drying the dispersion after being contacted with the oxidative gas exhibits a diffuse reflectance of 75% or more as measured at a wavelength of 700 nm.

### TECHNICAL FIELD

The present invention relates to a process for producing a dispersion of a copper ion-modified tungsten oxide photocatalyst, and a tungsten oxide photocatalyst modified with a copper ion.

### BACKGROUND ART

Titanium oxide is longtime known as a photocatalyst used for environmental purification treatments. However, the tungsten oxide has a wide band gap and therefore fails to exhibit a sufficient function as a photocatalyst in indoor use owing to a less amount of ultraviolet rays. In consequence, there have been made studies on visible light-responsive photocatalysts capable of exciting a band gap by irradiation with a visible light.

Tungsten oxide is longtime known as the visible light-responsive photocatalyst. In the attempt to allow the tungsten oxide to exhibit a good visible light photoactivity or improve the visible light photoactivity thereof, there have been proposed tungsten oxide catalysts on a surface of which a co-catalyst is supported. For example, the tungsten oxide on which a relatively inexpensive copper is supported in the form of a copper ion or copper oxide is capable of exhibiting a photocatalytic activity under irradiation with a visible light (for instance, refer to Non-Patent Document 1 and Patent Document 1).

In addition to researches on the above co-catalyst, it has been attempted to finely pulverize the tungsten oxide into fine particles in order to design photocatalysts having a high dispersibility and a high photocatalytic activity. For example, in Patent Document 2, it is described that meta-tungstic acid or a salt thereof is baked and then washed with water or hydrogen peroxide to obtain a photocatalyst having a high activity. However, the tungsten oxide obtained in Patent Document 2 has a large particle size and therefore tends to suffer from problems such as poor handling property upon preparing a coating material therefrom.

On the other hand, in Patent Document 3, it is described that metallic tungsten is sublimated or burned to prepare a fine tungsten oxide fume, and the tungsten oxide fume is then heat-treated to increase an activity thereof (refer to Patent Document 3). However, such a method described in Patent Document 3 is disadvantageous because it requires a large-scale facility. In addition, in the method, there also tends to arise such a problem that large care and measure must be taken upon treating such a nano-material in the form of a powder.

### CITATION LIST

### Patent Literature

Patent Document 1: JP 2008-149312A

Patent Document 2: JP 2009-148701A

Patent Document 3: JP 2008-264758A

### Non Patent Literature

Non-Patent Document 1: “Chemical Physics Letters”, 457(2008), 202-205, Hiroshi Irie, Shuhei Miura, Kazuhide Kamiya and Kazuhito Hashimoto

### SUMMARY OF THE INVENTION

### Problems to be Solved by the Invention

Hitherto, photocatalysts have been rarely used in the form of a powder, but frequently used in the form of a thin film. Therefore, the photocatalyst powder must be once formed into a solution or a coating liquid thereof. Also, as a medium for a dispersion of such a photocatalyst powder, an alcohol solvent is more suitably used than water in order to shorten a drying time of the dispersion as a coating liquid. For this reason, it is required that the photocatalyst powder is stably dispersed in the solvent. However, it will be difficult to form a stable dispersion of commercially available tungsten oxides because they have a particle size as large as 1 to 100 μm. Therefore, upon preparation of the dispersion, the tungsten oxides must be subjected to pulverization treatment using a ball mill, a beads mill, etc. The mechanical pulverization treatment however tends to cause undesirable change in crystal structure of the tungsten oxides or formation of lattice defects therein. This results in such a problem that a powder or a thin film obtained after drying the dispersion tends to be deteriorated in photocatalytic activity.

In consequence, there is an increasing demand for development of an alcohol dispersion of the tungsten oxide photocatalyst on which a co-catalyst is supported and which has a high productivity and exhibits a high photocatalytic activity when used in the form of a dried powder or thin film thereof. However, any effective alcohol dispersions of the tungsten oxide photocatalysts have not been obtained until now.

Under these circumstances, the present invention has been accomplished to solve the above conventional problems. An object of the present invention is to provide a process for producing a dispersion of a copper ion-modified tungsten oxide photocatalyst which has a high productivity and exhibits a high photocatalytic activity when used in the form of a dried powder or thin film thereof even though commercially available tungsten oxides are used as a raw material therefor. In addition, another object of the present invention is to provide a copper ion-modified tungsten oxide photocatalyst having a high photocatalytic activity.

Meanwhile, the “copper ion-modified tungsten oxide photocatalyst” is hereinafter occasionally referred to merely as a “copper-modified tungsten oxide photocatalyst”.

### Means for Solving the Problems

As a result of extensive and intensive researches for achieving the above objects, the present inventors have found that when subjecting copper ion-modified tungsten oxide particles to mechanical pulverization treatment in an organic solvent, a reduced species of tungsten is undesirably produced and causes deterioration in activity thereof. In addition, it has been found that when subjecting the dispersion obtained after the pulverization treatment to bubbling treatment with an oxidative gas, the reduced species of tungsten is oxidized again to thereby prepare a dispersion of a copper-modified tungsten oxide photocatalyst which contains a less amount of the reduced species, and further a powder or a thin film obtained by drying the dispersion (copper-modified tungsten oxide photocatalyst) can exhibit a high photocatalytic activity. The present invention has been completed on the basis of the above findings.

That is, the present invention relates to the following aspects.
[1] A process for producing a dispersion of a copper ion-modified tungsten oxide photocatalyst, including the steps of:

subjecting copper ion-modified tungsten oxide particles to mechanical pulverization treatment in a solvent; and

contacting the resulting dispersion of the pulverized particles with an oxygen gas or ozone.
[2] The process for producing a dispersion of a copper ion-modified tungsten oxide photocatalyst as described in the above aspect [1], wherein the solvent is an organic solvent.
[3] The process for producing a dispersion of a copper ion-modified tungsten oxide photocatalyst as described in the above aspect [2], wherein the organic solvent is an alcohol.
[4] The process for producing a dispersion of a copper ion-modified tungsten oxide photocatalyst as described in the above aspect [3], wherein the alcohol is at least one compound selected from the group consisting of methanol, ethanol, n-propyl alcohol and isopropyl alcohol.
[5] The process for producing a dispersion of a copper ion-modified tungsten oxide photocatalyst as described in any one of the above aspects [1] to [4], wherein a time of contacting the dispersion of the pulverized particles with the oxygen gas or ozone is 10 min or longer.
[6] A copper ion-modified tungsten oxide photocatalyst which is produced by subjecting copper ion-modified tungsten oxide particles to mechanical pulverization treatment in a solvent and then contacting the resulting dispersion of the pulverized particles with an oxidative gas, wherein a photocatalyst powder obtained by drying the dispersion after being contacted with the oxidative gas exhibits a diffuse reflectance of 75% or more as measured at a wavelength of 700 nm.
[7] The copper ion-modified tungsten oxide photocatalyst as described in the above aspect [6], wherein the photocatalyst powder exhibits a diffuse reflectance of 90% or more.
[8] The copper ion-modified tungsten oxide photocatalyst as described in the above aspect [6] or [7], wherein the photocatalyst powder has a specific surface area of from 20 to 100 m²/g.

### Effect of the Invention

In accordance with the present invention, it is possible to provide a process for producing a dispersion of fine particles of a copper-modified tungsten oxide photocatalyst which has a high productivity and exhibits a high photocatalytic activity when used in the form of a dried powder or thin film thereof even though commercially available tungsten oxides are used as a raw material thereof. In addition, there can also be provided a copper-modified tungsten oxide photocatalyst having a high photocatalytic activity.

### BRIEF DESCRIPTION OF THE DRAWING

FIG. 1 is a view showing a diffused reflection spectrum of a powder obtained by drying a dispersion of each of copper ion-modified tungsten oxide photocatalysts produced in Examples 1 and 5 and Comparative Example 1 at room temperature.

### PREFERRED EMBODIMENTS FOR CARRYING OUT THE INVENTION

### [Process for Producing Dispersion of Copper-Modified Tungsten Oxide Photocatalyst]

In the process for producing a dispersion of a copper ion-modified tungsten oxide photocatalyst according to the present invention, copper-modified tungsten oxide particles are subjected to mechanical pulverization treatment in a solvent (pulverization treatment step in solvent), and then the resulting dispersion of the pulverized tungsten oxide particles is contacted with an oxidative gas (oxidative gas contacting step). In the following, the respective steps are explained.

### (1) Pulverization Treatment Step in Solvent:

The pulverization treatment in this step is carried out using a wet mechanical treatment apparatus. Specific examples of the wet mechanical treatment apparatus usable in this step include pulverizers such as a ball mill, a high-speed rotary pulverizer and a media stirring mill. Among these pulverizers, a wet beads mill is preferably used in view of a good handling property and a high pulverizing efficiency. The beads mill facilitates production of finely pulverized particles, so that the resulting fine particles can be improved in dispersibility in the solvent.

The pulverizing time is preferably 1 h or longer. When pulverizing the particles for 1 h or longer, it is possible to obtain uniformly pulverized tungsten oxide particles.

Examples of the solvent include water and organic solvents (such as, for example, acetone, alcohols, ethers and ketones). Among these solvents, water and alcohols are preferred from the viewpoint of good environmental suitability. However, the use of water as the solvent may cause an undesirable change in crystal structure of the tungsten oxide owing to insertion of water molecules thereinto depending upon the pulverization conditions, so that the resulting photocatalyst may fail to exhibit a high photocatalytic activity.

Therefore, the alcohols that are free from such a risk are especially preferably used.

Examples of the alcohols include methanol, ethanol, n-propyl alcohol and isopropyl alcohol. Examples of the ethers include dimethyl ether, ethyl methyl ether and diethyl ether. Examples of the ketones include methyl ethyl ketone, diethyl ketone and methyl isobutyl ketone.

The copper ion-modified tungsten oxide in a powdered state which is obtained by the mechanical pulverization treatment preferably has a specific surface area of 20 m²/g or more, and more preferably 35 m²/g or more as measured by BET method, although not particularly limited thereto. The copper ion-modified tungsten oxide having a specific surface area of 20 m²/g or more is well dispersed in the organic solvent and can be prevented from suffering from considerable procession of solid-liquid separation.

The 50% particle size (D₅₀) and the 90% particle size (D₉₀) of the copper ion-modified tungsten oxide which is determined from scattering intensity-based distribution obtained in particle size distribution analysis by histogram method are preferably 250 nm or less and 400 nm or less, respectively, and more preferably 200 nm or less and 300 nm or less, respectively.

Incidentally, when production of the reduced species of tungsten in the tungsten oxide proceeds during the mechanical pulverization treatment, the color of the powder is changed from yellow to green.

As the method of modifying tungsten oxide with a copper ion (copper ion-modifying step), there may be used, for example, the method in which the tungsten oxide powder is mixed with a solution prepared by adding a cupric salt (divalent copper salt) such as copper chloride, copper acetate, copper sulfate and copper nitrate and preferably copper (II) chloride to a polar solvent, and the resulting dispersion is subjected to drying treatment to support the copper ions on a surface of the tungsten oxide.

The amount of the copper ions with which the tungsten oxide is modified is preferably from 0.01 to 0.06 part by mass, more preferably from 0.02 to 0.06 part by mass and most preferably from 0.02 to 0.04 part by mass in terms of metallic copper (Cu) on the basis of 100 parts by mass of the tungsten oxide.

When the modifying amount of the copper ions is 0.01 part by mass or more, the resulting photocatalyst can exhibit a good photocatalytic performance. When the modifying amount of the copper ions is 0.06 part by mass or less, the copper ions tend to be hardly aggregated together, so that the resulting photocatalyst can be prevented from suffering from deterioration in its photocatalytic performance.

### (2) Oxidative Gas Contacting Step:

In this step, the dispersion obtained through the pulverization treatment step in the organic solvent is brought into contact with an oxidative gas. By conducting this step, the reduced species of tungsten which will cause deterioration in activity of the photocatalyst is oxidized to thereby allow the resulting photocatalyst to exhibit a high photocatalytic activity.

Examples of the oxidative gas used in the above contacting step include an oxygen gas and ozone. Any of these oxidative gases may be used in combination with NOx, chlorine, etc. As the method of contacting the dispersion with the oxidative gas, there is preferably the method in which the oxidative gas is fed to the dispersion while bubbling the dispersion with the oxidative gas. In this case, the feed rate of the oxidative gas is preferably from 0.01 to 1 mL/min and more preferably from 0.05 to 0.2 mL/min per 100 mL of the dispersion.

The time of contacting the dispersion with the oxidative gas may vary depending upon the feed rate of the oxidative gas, and is preferably 10 min or longer and more preferably 1 h or longer. The contacting time of 10 min or longer is capable of uniformly treating the dispersion with the oxidative gas. In addition, the contacting time of 1 h or longer allows re-oxidation of the reduced species of tungsten to proceed sufficiently, so that the resulting photocatalyst can be further enhanced in its activity.

Although the oxidation reaction proceeds even by contacting the dispersion with the oxidative gas at room temperature, the dispersion may be heated to a temperature of several tens of degrees Celsius (for example, from 30 to 70° C.) to allow the oxidation reaction to proceed with a higher efficiency. In addition, the oxidation reaction using an organic solvent as the dispersing medium can be promoted by adding a small amount of water thereto as an assistant for the oxidation reaction. Further, the oxidation reaction can also proceed by contacting a powder or thin film formed of the dispersion with an oxidizing agent such as hydrogen peroxide, so that the resulting photocatalyst can be enhanced in an activity thereof.

Meanwhile, these methods may be used in combination with each other.

The degree of oxidation of tungsten contained in the copper ion-modified tungsten oxide may be determined by an absorbance as measured at a wavelength of 500 to 800 nm in a diffused reflection spectrum. The high absorbance indicates that a large amount of tungsten (W) in a low oxidized state is present in the tungsten oxide. Meanwhile, in the present invention, the degree of oxidation of tungsten in the tungsten oxide is determined from a diffuse reflectance obtained from such an absorbance as measured at a wavelength of 700 nm.

The degree of oxidation of tungsten is also approximately determined from a color of the dispersion although it is not exactly recognized. If the dispersion is tinted with a green color, it will be recognized that a large amount of tungsten in a low oxidized state is present. If the dispersion is tinted with a yellow color, it will be recognized that the tungsten is oxidized into a hexavalent state.

The dispersion of the copper ion-modified tungsten oxide photocatalyst according to the present invention which is obtained by undergoing the pulverization in the solvent and the contact with the oxidative gas may be present in various configurations. However, the copper ion-modified tungsten oxide photocatalyst is preferably used in the form of a powder or a thin film.

### (Copper Ion-Modified Tungsten Oxide Photocatalyst)

The copper-modified tungsten oxide photocatalyst according to the present invention is produced by the production process as described previously.

More specifically, the copper-modified tungsten oxide photocatalyst according to the present invention is produced by subjecting copper ion-modified tungsten oxide particles to mechanical pulverization treatment in a solvent and then contacting the resulting dispersion of the thus pulverized particles with an oxidative gas, wherein a photocatalyst powder obtained by drying the dispersion after being contacted with the oxidative gas to remove the solvent therefrom exhibits a diffuse reflectance of 75% or more as measured at a wavelength of 700 nm.

That is, when the reduced species contained in the tungsten oxide is forcibly oxidized with the oxidative gas (such as an oxygen gas and ozone), it is possible to obtain a dispersion of the copper ion-modified tungsten oxide powder having a diffuse reflectance of 75% or more as measured at a wavelength of 700 nm by a spectrophotometer.

When the diffuse reflectance of the tungsten oxide powder is less than 75%, the reduced species of tungsten being present on the photocatalyst is not sufficiently removed therefrom, so that the resulting photocatalyst fails to exhibit a high photocatalytic activity. The diffuse reflectance of the copper ion-modified tungsten oxide powder is preferably 75% or more and more preferably 90% or more.

The copper-modified tungsten oxide photocatalyst of the present invention may be practically used in the form of either particles or a thin film. When used in the form of particles, the copper-modified tungsten oxide photocatalyst preferably has a specific surface area of from 20 to 100 m²/g and more preferably from 35 to 70 m²/g. The specific surface area of the copper-modified tungsten oxide photocatalyst may be measured by BET method using nitrogen as an adsorbed species.

In addition, when using the copper-modified tungsten oxide photocatalyst of the present invention in the form of a thin film, the above copper-modified tungsten oxide photocatalyst in the form of particles may be dispersed in an organic solvent such as alcohols to prepare a dispersion. The thus prepared dispersion may be applied on a base material (such as, for example, metals, plastics and potteries) and then dried. The thickness of the thin film formed of the copper-modified tungsten oxide photocatalyst may vary depending upon the applications thereof, and is preferably from 0.1 to 10 μm and more preferably from 0.1 to 5 μm.

Further, the above dispersion may be mixed with a binder component to prepare a coating solution.

The photocatalyst of the present invention is capable of exhibiting a photocatalytic performance even when irradiated with a light having a wavelength of less than 420 nm, and can further exhibit a high photocatalytic performance when irradiated with a visible light having a wavelength of 420 nm or more.

The photocatalytic performance as used in the present invention may also include various other functions such as an antimicrobial property, an antiviral property, a deodorizing property, an anti-fouling property and environmental purification properties such as atmospheric air purification property and water purification property. Specific examples of the functions of the photocatalyst are illustrated below, although not particularly limited thereto.

That is, when any substances having an adverse influence on ambient environments, for example, organic compounds such as aldehydes, are present together with the photocatalyst particles in the reaction system, reduction in concentration of the organic compounds as well as increase in concentration of carbon dioxide as an oxidative decomposition product of the organic compounds can be more remarkably recognized under the irradiation with light as compared to the case where the system is present in a dark place.

### EXAMPLES

The present invention will be described in more detail below with reference to the following examples. However, these examples are only illustrative and not intended to limit the invention thereto.

Incidentally, various properties of the photocatalyst powders obtained in the following Examples and Comparative Example were measured or determined by the following methods.

### (1) Rate of Production of Carbon Dioxide

A glass Petri dish having a diameter of 1.5 cm was placed in a closed glass reaction container (capacity: 0.5 L), and 0.3 g of each of the photocatalyst powders obtained in respective Examples and Comparative Example was placed on the Petri dish. The interior of the reaction container was replaced with a mixed gas containing oxygen and nitrogen at a volume ratio of 1:4, and 5.2 μL of water (corresponding to a relative humidity of 50% (at 25° C.)) and 5.0 mL of 5.1% acetaldehyde (a mixed gas with nitrogen; normal condition: 25° C., 1 atm) were enclosed and sealed in the reaction container and irradiated with a visible light from outside of the reaction container. The irradiation with a visible light was carried out using a xenon lamp equipped with a UV-cut filter for cutting an ultraviolet ray having a wavelength of 400 nm or less (“L-42” (tradename) available from Asahi Techno Glass Co., Ltd.) as a light source. The rate of production of carbon dioxide as an oxidative decomposition product of the acetaldehyde was measured with time by gas chromatography. In addition, the catalyst used in the above measurement was such a catalyst from which no carbon dioxide was detected when measured under the condition that no acetaldehyde was still charged into the reaction container.

### (2) Diffuse Reflectance

Using a spectrophotometer equipped with an integrating sphere “UV-2400PC” (tradename) available from Shimadzu Seisakusho Corp., the diffuse reflectance was measured under irradiation with light having a wavelength of 700 nm in atmospheric air.

### (3) Method of Measuring Specific Surface Area

The specific surface area was measured using a full-automatic BET specific surface area measuring device “Macsorb, HM model-1208” (product name) available from Mountech Co., Ltd.

### (4) Measurement of Particle Size Distribution (Measurement of D₅₀ and D₉₀)

Using a zeta potential and particle size measuring system “ELSZ-2” (product name) available from Otsuka Electronics Co., Ltd., D₅₀ and D₉₀ were measured. Upon the measurement, there was used a solution (an alcohol dispersion of copper ion-modified tungsten oxide) whose solid concentration was adjusted to 5%.

### Example 1

Five hundred grams of a tungsten oxide powder (“F1-WO₃” available from Allied Material Corp.) were added to 4 L of a copper chloride aqueous solution (corresponding to 0.1% by mass in terms of Cu based on WO₃). While stirring, the resulting dispersion was heat-treated at 90° C. for 1 h, and then subjected to suction filtration to wash and recover solids therefrom. The thus recovered solids were dried at 120° C. over whole day and night and then pulverized in an agate mortar to obtain a tungsten oxide powder which was modified with 0.04% by mass of Cu and had a specific surface area of 9 m²/g as measured by BET method.

Next, 100 g of the thus obtained copper ion-modified tungsten oxide powder were dispersed in 90 g of a modified alcohol (standard composition: ethanol: 85.5% by weight; methanol: 4.9% by weight; n-propyl alcohol: 9.6% by weight; water: 0.2% by weight; “Solmix a7” available from Japan Alcohol Trading Co., Ltd.) and pulverized using a beads mill (“Pico Mill: pcr-lr” available from Asada Iron Works Co., Ltd.; zirconia beads: 0.5 mm (for preliminary pulverization); 0.1 mm (for substantial pulverization); packing rate: 90%) under such a condition that the mill was operated at a peripheral speed of 12 m/s while flowing the dispersion therethrough at a flow rate of 0.3 L/min for 60 min (upon the preliminary pulverization) and at a peripheral speed of 12 m/s while flowing the dispersion therethrough a flow rate of 0.3 L/min for 90 min (upon the substantial pulverization), thereby preparing an alcohol dispersion of the copper ion-modified tungsten oxide. The D₅₀ and D₉₀ of the copper ion-modified tungsten oxide in the thus prepared dispersion were 150 nm and 240 nm, respectively. Then, 100 mL of the alcohol dispersion of the copper ion-modified tungsten oxide were stirred for 3 h while bubbling the dispersion with oxygen containing 5% by volume of ozone which was prepared by passing through an ozone generator (“Model ed-Og-r3lt” available from Ecodesign Inc.) (feed rate: 0.1 mL/min) to thereby obtain an alcohol dispersion of the copper ion-modified tungsten oxide according to the present invention.

The thus treated dispersion was dried at room temperature, and the resulting solids were pulverized using an agate mortar, thereby obtaining a copper ion-modified tungsten oxide photocatalyst powder. The thus obtained powder had a BET specific surface area of 38 m²/g.

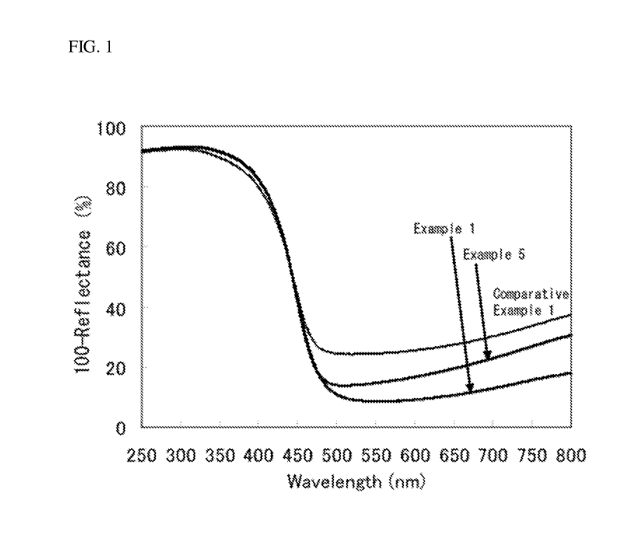

FIG. 1 shows a diffused reflection spectrum of the copper ion-modified tungsten oxide photocatalyst powder obtained after subjected to the bubbling treatment with ozone. From the absorption spectrum shown in FIG. 1, it was confirmed that the powder obtained in Example 1 had a lower absorbance as measured at a wavelength of 500 to 800 nm than that observed in the absorption spectrum of the powder obtained from the dispersion subjected to mechanical pulverization treatment only.

### Example 2

The alcohol dispersion of the copper ion-modified tungsten oxide obtained after the pulverization treatment using the beads mill in Example 1 which had D₅₀ of 150 nm, D₉₀ of 240 nm and a BET specific surface area of 38 m²/g was stirred for 30 min while bubbling the dispersion with oxygen containing 5% by volume of ozone which was prepared by passing through an ozone generator (feed rate: 0.1 mL/min) to thereby obtain an alcohol dispersion of the copper ion-modified tungsten oxide according to the present invention.

The thus treated dispersion was dried at room temperature, and the resulting solids were pulverized using an agate mortar, thereby obtaining a copper ion-modified tungsten oxide photocatalyst powder.

### Example 3

The alcohol dispersion of the copper ion-modified tungsten oxide obtained after the pulverization treatment using the beads mill in Example 1 which had D₅₀ of 150 nm, D₉₀ of 240 nm and a BET specific surface area of 38 m²/g was stirred for 10 min while bubbling the dispersion with oxygen containing 5% by volume of ozone which was prepared by passing through an ozone generator (feed rate: 0.1 mL/min) to thereby obtain an alcohol dispersion of the copper ion-modified tungsten oxide according to the present invention.

The thus treated dispersion was dried at room temperature, and the resulting solids were pulverized using an agate mortar, thereby obtaining a copper ion-modified tungsten oxide photocatalyst powder.

### Example 4

The alcohol dispersion of the copper ion-modified tungsten oxide obtained after the pulverization treatment using the beads mill in Example 1 which had D₅₀ of 150 nm, D₉₀ of 240 nm and a BET specific surface area of 38 m²/g was stirred for 4 h while bubbling the dispersion with oxygen containing 5% by volume of ozone which was prepared by passing through an ozone generator (feed rate: 0.1 mL/min) to thereby obtain an alcohol dispersion of the copper ion-modified tungsten oxide according to the present invention.

The thus treated dispersion was dried at room temperature, and the resulting solids were pulverized using an agate mortar, thereby obtaining a copper ion-modified tungsten oxide photocatalyst powder.

### Example 5

The alcohol dispersion of the copper ion-modified tungsten oxide obtained after the pulverization treatment using the beads mill in Example 1 which had D₅₀ of 150 nm, D₉₀ of 240 nm and a BET specific surface area of 38 m²/g was stirred for 1 h while bubbling the dispersion with oxygen (feed rate: 0.1 mL/min) to thereby obtain an alcohol dispersion of the copper ion-modified tungsten oxide according to the present invention.

The thus treated dispersion was dried at room temperature, and the resulting solids were pulverized using an agate mortar, thereby obtaining a copper ion-modified tungsten oxide photocatalyst powder.

In FIG. 1, there is shown a diffused reflection spectrum of the copper ion-modified tungsten oxide photocatalyst powder obtained after the bubbling treatment with oxygen.

### Example 6

The alcohol dispersion of the copper ion-modified tungsten oxide obtained after the pulverization treatment using the beads mill in Example 1 which had D₅₀ of 150 nm, D₉₀ of 240 nm and a BET specific surface area of 38 m²/g was stirred for 30 min while bubbling the dispersion with oxygen (feed rate: 0.1 mL/min) to thereby obtain an alcohol dispersion of the copper ion-modified tungsten oxide according to the present invention. The thus treated dispersion was dried at room temperature, and the resulting solids were pulverized using an agate mortar, thereby obtaining a copper ion-modified tungsten oxide photocatalyst powder.

### Example 7

The alcohol dispersion of the copper ion-modified tungsten oxide obtained after the pulverization treatment using the beads mill in Example 1 which had D₅₀ of 150 nm, D₉₀ of 240 nm and a BET specific surface area of 38 m²/g was stirred for 10 min while bubbling the dispersion with oxygen (feed rate: 0.1 mL/min) to thereby obtain an alcohol dispersion of the copper ion-modified tungsten oxide according to the present invention.

The thus treated dispersion was dried at room temperature, and the resulting solids were pulverized using an agate mortar, thereby obtaining a copper ion-modified tungsten oxide photocatalyst powder.

### Comparative Example 1

The alcohol dispersion of tungsten oxide was produced in the same manner as in Example 1 except that the dispersion was subjected to no bubbling treatment with oxygen which had passed through an ozone generator. The thus produced dispersion was dried at room temperature, and the resulting solids were pulverized using an agate mortar, thereby obtaining a copper ion-modified tungsten oxide photocatalyst powder. The thus obtained powder had a BET specific surface area of 38 m²/g.

In FIG. 1, there is shown a diffused reflection spectrum of the copper ion-modified tungsten oxide photocatalyst powder before irradiation with an ultraviolet ray.

The photocatalytic activity and diffuse reflectance of each of the photocatalyst powders obtained in Examples 1 to 7 and Comparative Example 1 are shown in Table 1 below. Meanwhile, a true amount of carbon dioxide derived from acetaldehyde was determined by subtracting an amount of carbon dioxide produced immediately before irradiating the photocatalyst powder with light from an amount of carbon dioxide produced after irradiating the photocatalyst powder with light for 8 h.

TABLE 1

| | | Amount of carbon |
|---|---|---|
| | Diffuse reflectance at a | dioxide produced |
| | wavelength of 700 nm (%) | (ppm by volume) |
| Example 1 | 88 | 639 |
| Example 2 | 91 | 600 |
| Example 3 | 90 | 620 |
| Example 4 | 91 | 646 |
| Example 5 | 78 | 540 |
| Example 6 | 76 | 446 |
| Example 7 | 77 | 465 |
| Comparative Example 1 | 70 | 75 |

From the above results, it was confirmed that the photocatalyst powder obtained from the alcohol dispersion of the copper ion-modified tungsten oxide photocatalyst according to the present invention was capable of producing carbon dioxide in an amount of about 9 times in maximum an amount of carbon dioxide produced by using the powder obtained from the alcohol dispersion of the copper ion-modified tungsten oxide photocatalyst which was not subjected to oxidation treatment (Comparative Example 1). Therefore, the photocatalyst of the present invention is apparently enhanced in photocatalytic activity.

The deterioration in activity of the copper ion-modified tungsten oxide upon the pulverization treatment in the organic solvent tends to be caused by production of the reduced species of tungsten (W). The reduced species of tungsten (W) tends to form a impurity level in a band gap of WO₃ so that the photocatalyst exhibits an increased absorption on a long wavelength side. As shown in FIG. 1, the diffuse reflectance of the copper ion-modified tungsten oxide obtained in Comparative Example 1 was 70% as measured at a wavelength of 700 nm, and the color tone of the photocatalyst was a green color.

On the other hand, the sample obtained in Example 5 had a diffuse reflectance of 78%, and the color tone thereof was a dark yellow color, and further the sample obtained in Example 1 had a diffuse reflectance of about 90%, and the color tone thereof was a clear yellow color. The yellow color tone of the photocatalyst indicates that an amount of the reduced species of tungsten (W) therein is small. Thus, in order to allow the photocatalyst to exhibit a high activity, it is essentially required that the photocatalyst has such a yellow color.

1. A process for producing a dispersion of a copper ion-modified tungsten oxide photocatalyst, comprising the steps of:
subjecting copper ion-modified tungsten oxide particles to mechanical pulverization treatment in a solvent; and
contacting the resulting dispersion of the pulverized particles with an oxygen gas or ozone.

2. The process for producing a dispersion of a copper ion-modified tungsten oxide photocatalyst according to claim 1, wherein the solvent is an organic solvent.

3. The process for producing a dispersion of a copper ion-modified tungsten oxide photocatalyst according to claim 2, wherein the organic solvent is an alcohol.

4. The process for producing a dispersion of a copper ion-modified tungsten oxide photocatalyst according to claim 3, wherein the alcohol is at least one compound selected from the group consisting of methanol, ethanol, n-propyl alcohol and isopropyl alcohol.

5. The process for producing a dispersion of a copper ion-modified tungsten oxide photocatalyst according to claim 1, wherein a time of contacting the dispersion of the pulverized particles with the oxygen gas or ozone is 10 min or longer.

6. A copper ion-modified tungsten oxide photocatalyst which is produced by subjecting copper ion-modified tungsten oxide particles to mechanical pulverization treatment in a solvent and then contacting the resulting dispersion of the pulverized particles with an oxidative gas, wherein a photocatalyst powder obtained by drying the dispersion after being contacted with the oxidative gas exhibits a diffuse reflectance of 75% or more as measured at a wavelength of 700 nm.

7. The copper ion-modified tungsten oxide photocatalyst according to claim 6, wherein the photocatalyst powder exhibits a diffuse reflectance of 90% or more.

8. The copper ion-modified tungsten oxide photocatalyst according to claim 6, wherein the photocatalyst powder has a specific surface area of from 20 to 100 m²/g.
